(19) United States
(12) Patent Application Publication
(10) Pub. No.: US 2022/0254059 A1
(43) Pub. Date: Aug. 11, 2022

(54) Data Processing Method and Related Device

(71) Applicant: Shenzhen Sensetime Technology Co., Ltd., Shenzhen (CN)

(72) Inventors: Tao Zhou, Shenzhen (CN); Xingyao Yu, Shenzhen (CN)

(73) Assignee: Shenzhen Sensetime Technology Co., Ltd., Shenzhen (CN)

(21) Appl. No.: 17/731,398

(22) Filed: Apr. 28, 2022

Related U.S. Application Data
(63) Continuation of application No. PCT/CN2019/127043, filed on Dec. 20, 2019.

(30) Foreign Application Priority Data
Oct. 31, 2019 (CN) 201911053659.2

(51) Int. Cl. G06T 7/73; G06T 7/11; G06T 3/60; G06T 3/20; G06T 7/66

(52) U.S. Cl. CPC G06T 7/73; G06T 7/11; G06T 3/60; G06T 2207/30108; G06T 7/66; G06T 2207/10028; G06T 3/20

(57) ABSTRACT

The present disclosure relates to a data processing method and a related device. The method comprises the following steps of: acquiring a point cloud to be processed which comprises at least one object to be located; determining at least two target areas in the point cloud to be processed, adjusting normal vectors of points in the target areas to significant normal vectors according to initial normal vectors of the points in the target areas, any two of the at least two target areas being different; dividing the point cloud to be processed according to the significant normal vectors of the target areas to acquire at least one divided area; and acquiring a three-dimensional position of a reference point of the object to be positioned according to three-dimensional positions of the point in the at least one divided area.

### CROSS-REFERENCE TO RELATED APPLICATION

The present disclosure is a continuation of and claims priority under 35 U.S.C. 120 to PCT Application. No. PCT/CN2019/127043, filed on Dec. 20, 2019, which claims priority to Chinese Patent Application No. 201911053659.2, filed with China National Intellectual Property Administration on Oct. 31, 2019, entitle “Data Processing Method and Related Device”. All the above referenced priority documents are incorporated herein by reference in their entireties.

### TECHNICAL FIELD

The present disclosure relates to the technical field of artificial intelligence, in particular to a data processing method and a related device.

### BACKGROUND

With the deepening of research on robots and the huge growth of demand for robots in various fields, the application fields of robots are expanding, such as gripping objects stacked in material frames by robots. Gripping stacked objects by robots requires firstly recognizing the position and posture (hereinafter referred to as the pose) of the objects to be gripped in space, and then gripping the objects according to the recognized pose. According to the conventional approach, feature points are extracted from an image, then feature matching is performed between the image and a preset reference image to obtain matched feature points, and the position of the object to be gripped in the camera coordinate system is determined according to the matched feature points, and then, according to the calibration parameters of the camera, the pose of the object can be solved.

### SUMMARY

The present disclosure provides a data processing method and a related device.

In a first aspect, a data processing method is provided, which comprises the following steps: acquiring a point cloud to be processed, wherein the point cloud to be processed comprises at least one object to be located; determining at least two target areas in the point cloud to be processed, and adjusting normal vectors of the points in the target areas to significant normal vectors according to initial normal vectors of the points in the target areas, wherein any two of the at least two target areas are different; dividing the point cloud to be processed according to the significant normal vectors of the target areas to obtain at least one divided area; and acquiring a three-dimensional position of a reference point of the object to be located according to the three-dimensional positions of the points in the at least one divided area.

In this aspect, the point cloud is divided according to the significant normal vectors of the target areas, so as to improve the division accuracy. Furthermore, when the three-dimensional position of the reference point of the object to be located is determined according to the three-dimensional positions of the points in the divided areas obtained by division, the accuracy of the three-dimensional position of the reference point of the object to be located can be improved.

In a possible implementation mode, the at least two target areas comprise a first target area and a second target area, the initial normal vectors comprise a first initial normal vector and a second initial normal vector, and the significant normal vectors comprise a first significant normal vector and a second significant normal vector; and adjusting the normal vectors of the points in the target areas into significant normal vectors according to the initial normal vectors of the points in the target areas comprises adjusting the normal vectors of the points in the first target area to the first significant normal vector according to the first initial normal vectors of the points in the first target area, and adjusting the normal vectors of the points in the second target area to the second significant normal vector according to the second initial normal vectors of the points in the second target area.

In this possible implementation mode, a significant normal vector is determined for each of the at least two target areas, such that the point cloud to be processed can be divided in the subsequent processing according to the normal vector of each target area.

In another possible implementation mode, dividing the point cloud to be processed according to the significant normal vectors of the target areas to obtain at least one divided area comprises dividing the point cloud to be processed according to the first significant normal vector and the second significant normal vector to obtain the at least one divided area.

In this possible implementation mode, the point cloud to be processed is divided according to the significant normal vectors of different target areas, so as to improve the division accuracy, and further improve the accuracy of the obtained three-dimensional position of the reference point of the object to be located.

In yet another possible implementation mode, adjusting the normal vectors of the points in the first target area to the first significant normal vector according to the first initial normal vectors of the points in the first target area comprises: clustering the first initial normal vectors of the points in the first target area to obtain at least one cluster set; taking the cluster set with the largest number of the first initial normal vectors in the at least one cluster set as a target cluster set, and determining the first significant normal vector according to the first initial normal vectors in the target cluster set; and adjusting the normal vectors of the points in the first target area to the first significant normal vector.

In this possible implementation mode, by adjusting the normal vectors of the points in the first target area to the first significant normal vector, the influence of noise in the first target area on subsequent processing is reduced, and the accuracy of the acquired pose of the object to be located is improved.

In yet another possible implementation mode, clustering the first initial normal vectors to obtain the at least one cluster set comprises mapping the first initial normal vectors of the points in the first target area to any one of at least one preset section, the preset section being used for representing vectors, vectors represented by any two of the at least one preset section are different; taking the preset section with the largest number of the first initial normal vectors as a target preset section; and determining the first significant normal vector according to the first initial normal vectors included in the target preset section.

In yet another possible implementation mode, determining the first significant normal vector according to the first initial normal vectors included in the target preset section comprises determining a mean value of the first initial normal vectors in the target preset section as the first significant normal vector; or, determining a median value of the first initial normal vectors in the target preset section as the first significant normal vector.

In yet another possible implementation mode, dividing the point cloud to be processed according to the first significant normal vector and the second significant normal vector to obtain at least one divided area comprises determining a projection of the first target area on a plane perpendicular to the first significant normal vector to obtain a first projection plane; determining a projection of the second target area on a plane perpendicular to the second significant normal vector to acquire a second projection plane; and dividing the first projection plane and the second projection plane to acquire the at least one divided area.

Since a distance between the first projection plane and the second projection plane is greater than a distance between the first target area and the second target area, by projecting the first target area and the second target area in this possible implementation mode, the effect of “increasing” the distance between the first target area and the second target area can be achieved, thereby improving the accuracy of the division processing.

In yet another possible implementation mode, dividing the first projection plane and the second projection plane to obtain the at least one divided area comprises constructing a first neighborhood with any point in the first projection plane and the second projection plane as a starting point and a first preset value as a radius; determining a point in the first neighborhood whose similarity with the starting point is greater than or equal to a first threshold as a target point; and taking areas containing the target point and the starting point as divided areas to obtain the at least one divided area.

In yet another possible implementation mode, acquiring the three-dimensional position of the reference point of the object to be located according to the three-dimensional positions of the points in the at least one divided area comprises determining a first mean value of the three-dimensional positions of the points in a target divided area in the at least one divided area; and determining the three-dimensional position of the reference point of the object to be located according to the first mean value.

In yet another possible implementation mode, after determining the first mean value of the three-dimensional positions of the points in the at least one divided area, the method further comprises determining a second mean value of the normal vectors of the points in the target divided area; acquiring a model point cloud of the object to be located, wherein an initial three-dimensional position of the model point cloud is the first mean value, and a pitch angle of the model point cloud is determined by the second mean value; moving the target divided area to make a coordinate system of the target divided area coincide with a coordinate system of the model point cloud to obtain a first rotation matrix and/or a first translation amount; and acquiring a posture angle of the object to be located according to the first rotation matrix and/or the first translation amount and the normal vectors of the target divided area.

In this possible implementation, the object coordinate system of the target divided area is coincided with the object coordinate system of the model point cloud by rotating and/or moving the target divided area to determine a yaw angle of the object to be located, such that the accuracy of the yaw angle of the object to be located can be improved and the three-dimensional position of the reference point of the object to be located can be corrected. In addition, the posture of the object to be located can be determined according to the yaw angle of the object to be located.

In yet another possible implementation mode, the method further comprises moving the target divided area in the case where the coordinate system of the target divided area coincides with the coordinate system of the model point cloud such that the points in the target divided area coincide with the reference point of the model point cloud, to obtain a reference position of the target divided area; determining a coincidence degree between the target divided area at the reference position and the model point cloud; taking the reference position corresponding to a maximum value of the coincidence degree as a target reference position; and determining a third mean value of the three-dimensional positions of the points in the target divided area at the target reference position as a first adjusted three-dimensional position of the reference point of the object to be located.

In this possible implementation mode, based on the coincidence degree between the target divided area and the model point cloud, the first adjusted three-dimensional position of the reference point of the object to be located is acquired, such that the three-dimensional position of the reference point of the object to be located is corrected.

In yet another possible implementation mode, determining the coincidence degree between the target divided area at the reference position and the model point cloud comprises determining a distance between a first point in the target divided area at the reference position and a second point in the model point cloud, the second point being a point in the model point cloud closest to the first point; in the case where the distance is smaller than or equal to a second threshold, increasing a coincidence degree index of the reference position by a second preset value; and determining the coincidence degree according to the coincidence degree index, the coincidence degree index being positively correlated with the coincidence degree.

In yet another possible implementation mode, the method further comprises adjusting the three-dimensional position of the reference point of the model point cloud to the third mean value; rotating and/or translating the target divided area at the target reference position to make the distance between the first point and a third point in the model point cloud smaller than or equal to a third threshold to obtain a second rotation matrix and/or a second translation amount, the third point being a point in the model point cloud when the three-dimensional position of the reference point is the third mean value closest to the first point; and adjusting the three-dimensional position of the reference point of the object to be located according to the second rotation matrix and/or the second translation amount to obtain a second adjusted three-dimensional position of the reference point of the object to be located, and adjusting the posture angle of the object to be located according to the second rotation matrix and/or the second translation amount to obtain an adjusted posture angle of the object to be located.

In this possible implementation mode, the three-dimensional position of the reference point of the target divided area and the posture angle of the target divided area are corrected by rotating and/or translating the target divided area at the target reference position, to obtain the second adjusted three-dimensional position of the reference point of the object to be located and the adjusted posture angle of the object to be located, thus achieving the effect of correcting the pose of the object to be located.

In yet another possible implementation mode, the method further comprises transforming the three-dimensional position of the reference point of the object to be located and the posture angle of the object to be located into a three-dimensional position to be gripped and a posture angle to be gripped in a robot coordinate system; acquiring a mechanical claw model and an initial pose of the mechanical claw model; acquiring a gripping path for the mechanical claw to grip the object to be located in the point cloud according to the three-dimensional position to be gripped, the posture angle to be gripped, the mechanical claw model, and the initial pose of the mechanical claw model; and determining that the object to be located is a non-grippable object when the number of the points not belonging to the object to be located in the gripping path is greater than or equal to a fourth threshold.

In this possible implementation mode, by determining the number of the points not belonging to the object to be located in the gripping path, it can be determined whether there are “obstacles” in the gripping path, and it can further be determined whether the object to be located is a grippable object. In this way, the success rate of gripping the object to be located by the mechanical claw can be improved, and the probability of occurrence of accidents when gripping the object to be located due to the existence of obstacles in the gripping path can be reduced.

In yet another possible implementation mode, determining at least two target areas in the point cloud to be processed comprises determining at least two target points in the point cloud; and constructing the at least two target areas by taking each of the at least two target points as a sphere center and a third preset value as a radius, respectively.

In yet another possible implementation mode, acquiring the point cloud to be processed comprises acquiring a first point cloud and a second point cloud, wherein the first point cloud comprises a point cloud of a scene where the at least one object to be located is located, and the second point cloud comprises the at least one object to be located and a point could of a scene where the at least one object to be located is located; determining identical data in the first point cloud and the second point cloud; and removing the identical data from the second point cloud to obtain the point cloud to be processed.

In this possible implementation mode, the point cloud to be processed is obtained by determining identical data in the first point cloud and the second point cloud and removing the identical data from the second point cloud, such that the data processing amount for subsequent processing is reduced and the processing speed is improved.

In yet another possible implementation mode, the reference point is one of a centroid, a gravity center, and a geometric center.

In a second aspect, there is provided a data processing device, comprising:

an acquisition unit configured to acquire a point cloud to be processed, the point cloud to be processed comprising at least one object to be located;

an adjusting unit configured to determine at least two target areas in the point cloud to be processed, and adjust normal vectors of points in the target areas to significant normal vectors according to initial normal vectors of the points in the target areas, any two of the at least two target areas being different;

a division processing unit configured to divide the point cloud to be processed according to the significant normal vectors of the target areas to acquire at least one divided area; and

a first processing unit configured to acquire a three-dimensional position of a reference point of the object to be located according to three-dimensional positions of points in the at least one divided area.

In a possible implementation mode, the at least two target areas comprise a first target area and a second target area, the initial normal vectors comprise a first initial normal vector and a second initial normal vector, and the significant normal vectors comprise a first significant normal vector and a second significant normal vector; and the adjusting unit is configured to adjust the normal vectors of the points in the first target area to the first significant normal vector according to the first initial normal vectors of the points in the first target area, and adjust the normal vectors of the points in the second target area to the second significant normal vector according to the second initial normal vectors of the points in the second target area.

In another possible implementation mode, the division processing unit is configured to divide the point cloud to be processed according to the first significant normal vector and the second significant normal vector to acquire the at least one divided area.

In yet another possible implementation mode, the adjusting unit is configured to cluster the first initial normal vectors of the points in the first target area to acquire at least one cluster set; a cluster set with the largest number of the first initial normal vectors in the at least one cluster set is taken as a target cluster set, and the first significant normal vector is determined according to the first initial normal vectors in the target cluster set; and the normal vectors of the points in the first target area are adjusted to the first significant normal vector.

In yet another possible implementation mode, the adjusting unit is specifically configured to map the first initial normal vectors of the points in the first target area to any one of at least one preset section, the preset section being used for representing vectors, vectors represented by any two of the at least one preset section being different; a preset section with the largest number of the first initial normal vectors is taken as a target preset section; and the first significant normal vector is determined according to the first initial normal vectors included in the target preset section.

In yet another possible implementation mode, the adjusting unit is specifically configured to determine a mean value of the first initial normal vectors in the target preset section as the first significant normal vector; or, determine a median value of the first initial normal vectors in the target preset section as the first significant normal vector.

In yet another possible implementation mode, the division processing unit is configured to determine projection of the first target area on a plane perpendicular to the first significant normal vector to acquire a first projection plane; determine projection of the second target area on a plane perpendicular to the second significant normal vector to acquire a second projection plane; and divide the first projection plane and the second projection plane to acquire the at least one divided area.

In yet another possible implementation mode, the division processing unit is specifically configured to construct a first neighborhood with any point in the first projection plane and the second projection plane as a starting point and a first preset value as a radius; determine a point in the first neighborhood whose similarity with the starting point is greater than or equal to a first threshold as a target point; and take areas containing the target point and the starting point as divided areas to acquire the at least one divided area.

In yet another possible implementation mode, the first processing unit is configured to determine a first mean value of the three-dimensional positions of the points in a target divided area in the at least one divided area; and determine the three-dimensional position of the reference point of the object to be located according to the first mean value.

In yet another possible implementation mode, the device further comprises a determination unit configured to determine a second mean value of the normal vectors of the points in the target divided area after determining the first mean value of the three-dimensional positions of the points in the at least one divided area; the acquisition unit configured to acquire a model point cloud of the object to be located, wherein an initial three-dimensional position of the model point cloud is the first mean value, and a pitch angle of the model point cloud is determined by the second mean value; a moving unit configured to move the target divided area to make a coordinate system of the target divided area coincide with a coordinate system of the model point cloud to acquire a first rotation matrix and/or a first translation amount; and the first processing unit configured to acquire a posture angle of the object to be located according to the first rotation matrix and/or the first translation amount and the normal vectors of the target divided area.

In yet another possible implementation mode, the moving unit is further configured to move the target divided area in the case where the coordinate system of the target divided area coincides with the coordinate system of the model point cloud such that the points in the target divided area coincide with the reference point of the model point cloud, to acquire a reference position of the target divided area; the determination unit is further configured to determine a coincidence degree between the target divided area at the reference position and the model point cloud; the determination unit is further configured to take the reference position corresponding to a maximum value of the coincidence degree as a target reference position; and the first processing unit is configured to determine a third mean value of the three-dimensional positions of the points in the target divided area at the target reference position as a first adjusted three-dimensional position of the reference point of the object to be located.

In yet another possible implementation mode, the determination unit is specifically configured to determine a distance between a first point in the target divided area at the reference position and a second point in the model point cloud, the second point being a point in the model point cloud closest to the first point; in the case where the distance is smaller than or equal to a second threshold, increase a coincidence degree index of the reference position by a second preset value; and determine the coincidence degree according to the coincidence degree index, the coincidence degree index being positively correlated with the coincidence degree.

In yet another possible implementation mode, the adjusting unit is further configured to adjust the three-dimensional position of the reference point of the model point cloud to the third mean value; the device further comprises a second processing unit configured to make the distance between the first point and a third point in the model point cloud smaller than or equal to a third threshold by rotating and/or translating the target divided area at the target reference position, to acquire a second rotation matrix and/or a second translation amount, the third point being a point in the model point cloud when the three-dimensional position of the reference point is the third mean value closest to the first point; and the first processing unit further configured to adjust the three-dimensional position of the reference point of the object to be located according to the second rotation matrix and/or the second translation amount to acquire a second adjusted three-dimensional position of the reference point of the object to be located, and adjust the posture angle of the object to be located according to the second rotation matrix and/or the second translation amount to acquire an adjusted posture angle of the object to be located.

In yet another possible implementation mode, the device further comprises a transforming unit configured to transform the three-dimensional position of the reference point of the object to be located and the posture angle of the object to be located into a three-dimensional position to be gripped and a posture angle to be gripped in a robot coordinate system; the acquisition unit further configured to acquire a mechanical claw model and an initial pose of the mechanical claw model; the first processing unit further configured to acquire a gripping path for the mechanical claw to grip the object to be located in the point cloud according to the three-dimensional position to be gripped, the posture angle to be gripped, the mechanical claw model and the initial pose of the mechanical claw model; and the determination unit further configured to determine that the object to be located is a non-grippable object when the number of the points not belonging to the object to be located in the gripping path is greater than or equal to a fourth threshold.

In yet another possible implementation mode, the adjusting unit is configured to determine at least two target points in the point cloud; and construct the at least two target areas by taking each of the at least two target points as a sphere center and a third preset value as a radius, respectively.

In yet another possible implementation mode, the acquisition unit is configured to acquire a first point cloud and a second point cloud, wherein the first point cloud comprises a point cloud of a scene where the at least one object to be located is located, and the second point cloud comprises the at least one object to be located and a point could of a scene where the at least one object to be located is located; determine identical data in the first point cloud and the second point cloud; and remove the identical data from the second point cloud to acquire the point cloud to be processed.

In yet another possible implementation mode, the reference point is one of a centroid, a gravity center, and a geometric center.

In a third aspect, there is provided a processor for carrying out a method as described in the first aspect and any possible implementation mode thereof.

In a fourth aspect, there is provided an electronic apparatus, which comprises a processor, a transmitting device, an input device, an output device and a memory, wherein the memory is configured to store computer program codes which comprise computer instructions, and when the processor executes the computer instructions, the electronic apparatus carries out a method as described in the first aspect and any possible implementation mode thereof.

In a fifth aspect, there is provided a computer readable storage medium, in which a computer program is stored, the computer program comprising a program instruction which, when executed by a processor of an electronic apparatus, causes the processor to carry out a method as described in the first aspect and any possible implementation mode thereof.

In a sixth aspect, there is provided a computer program product including instructions that, when run on a computer, causes the computer to carry out a method as described in the first aspect and any possible implementation mode thereof.

It is to be understood that the above general description and the following detailed description are only exemplary and explanatory, and are not intended to limit the present disclosure.

### BRIEF DESCRIPTION OF THE DRAWINGS

To more clearly explain the technical solutions in the embodiments or the background art of the present disclosure, the following explanation will be given to the drawings that need to be used in the embodiments or the background art of the present disclosure.

The drawings herein are incorporated into and constitute a part of the description, and illustrate the embodiments in conformity with the present disclosure. The drawings, together with the description, are used to describe the technical solutions of the present disclosure.

FIG. 1 is a schematic flow diagram of a data processing method provided by an embodiment of the present disclosure;

FIG. 2 is a schematic flow diagram of another data processing method provided by an embodiment of the present disclosure;

FIG. 3 is a schematic flow diagram of another data processing method provided by an embodiment of the present disclosure;

FIG. 4 is a schematic flow diagram of another data processing method provided by an embodiment of the present disclosure;

FIG. 5 is a schematic structural diagram of a data processing device provided by an embodiment of the present disclosure; and

FIG. 6 is a schematic diagram of a hardware structure of a data processing device provided by an embodiment of the present disclosure.

### DETAILED DESCRIPTION

To enable those skilled in the art to better understand the technical solutions of the present disclosure, the technical solutions in the embodiments of the present disclosure will be described clearly and completely with reference to the drawings in the embodiments of the present disclosure. Obviously, the embodiments described below are only part of the embodiments of the present disclosure, not all of them. Based on the embodiments described herein, all other embodiments obtained by ordinary technicians in the art without making creative efforts fall within the protection scope of the present disclosure.

The terms “first”, “second” and the like in the description, the claims and the aforementioned drawings of the present disclosure are used to distinguish different objects, but not to describe a specific order. Furthermore, the terms “comprise” and “have” and any variations thereof are intended to cover non-exclusive inclusion. For example, a process, a method, a system, a product or an apparatus comprising a series of steps or units is not limited to the listed steps or units, but optionally further comprises steps or units not listed, or optionally further comprises other steps or units inherent in the process, method, product or apparatus.

The term “and/or” herein only indicates an association relation for describing associated objects, implying that there can be three types of relations. For example, A and/or B implies three cases, that is, A exists alone, A and B exist at the same time, and B exists alone. In addition, the term “at least one” herein implies any one of a plurality of something or any combination of at least two of a plurality of something. For example, comprising at least one of A, B and C may imply comprising any one or more elements selected from a group consisting of A, B and C.

The “embodiment” mentioned herein implies that a particular feature, structure or characteristic described with reference to an embodiment may be included in at least one embodiment of the present disclosure. The appearance of the term “embodiment” in various parts in the description does not necessarily mean the same embodiment, or an independent or alternative embodiment mutually exclusive with other embodiments. Those skilled in the art understand explicitly and implicitly that an embodiment described herein can be combined with other embodiments.

In the industrial field, the parts to be assembled are usually placed in the material frame or tray, and assembling the parts placed in the material frame or tray is an important part in the assembly process. Because of the huge number of parts to be assembled, the manual assembly is inefficient and the labor cost is high.

Feature matching between a point cloud containing parts to be assembled and a pre-stored reference point cloud can determine a pose of the parts to be assembled in space. However, when noise exists in the point cloud containing the parts to be assembled, the accuracy of feature matching between the point cloud containing the parts to be assembled and pre-stored reference point cloud will be reduced, thus reducing the accuracy of the acquired pose of the parts to be assembled. According to the technical solutions provided by the embodiments of the present disclosure, the accuracy of the acquired pose of the parts to be assembled can be improved in the case where noise exists in the point cloud containing the parts to be assembled.

The data processing solution provided by the embodiments of the present disclosure can be applied to any scene where a three-dimensional position of an object needs to be determined. For example, it can be applied to the scene where an object to be gripped is gripped by a mechanical claw, or to the scene where an object at an unknown position is located. The embodiments of the present disclosure will be described below with reference to the drawings in the embodiments of the present disclosure.

Refer to FIG. 1 which is a schematic flow diagram of a data processing method provided by an embodiment of the present disclosure.

101. Acquire a point cloud to be processed, which comprises at least one object to be located.

The executing body of the technical solutions disclosed in the embodiments of the present disclosure can be a terminal, a server or other target detection devices. A terminal may be a User Equipment (UE), a mobile device, a user terminal, a terminal, a cellular phone, a cordless phone, a Personal Digital Assistant (PDA), a handheld device, a computing device, a vehicle-mounted device, a wearable device and the like. In some possible implementation modes, the technical solutions of the present disclosure can also be implemented by a processor calling a computer readable instruction stored in a memory.

In the embodiments of the present disclosure, the object to be located comprises the aforementioned parts to be assembled. Each point in the point cloud to be processed includes three-dimensional position information.

In a possible implementation mode of acquiring the point cloud to be processed, the terminal can receive the point cloud to be processed input by the user through an input component, wherein the input component includes a keyboard, a mouse, a touch screen, a touch pad, an audio input device and the like. The terminal may also receive a point cloud to be processed transmitted by a second terminal (a terminal other than the executing body in the technical solutions disclosed in the embodiments of the present disclosure), wherein the second terminal includes a mobile phone, a computer, a tablet computer, a server, and the like.

The executing body in the technical solutions disclosed by the embodiments of the present disclosure can also be a robot loaded with a three-dimensional laser scanner.

In an actual scene, because the aforementioned at least one object to be located is placed in a material frame or a material tray, it is difficult to directly acquire a point cloud of the at least one object to be located in a stacked state, but instead a point cloud including the object to be located and the material frame (or material tray) can be acquired. As the number of points contained in the point cloud is huge, the calculation amount involved in processing the point cloud is also very large. Therefore, if the point cloud containing the at least one object to be located is processed, the calculation amount can be reduced and the processing speed can be improved. In a possible implementation mode, a first point cloud and a second point cloud are acquired, wherein the first point cloud comprises a point cloud of a scene where the at least one object to be located is located, and the second point cloud comprises the at least one object to be located and a point could of a scene where the at least one object to be located is located. Identical data in the first point cloud and the second point cloud is determined. The identical data is removed from the second point cloud to obtain the point cloud to be processed. In a possible implementation mode of acquiring the first point cloud, at least one object to be located and a scene where the at least one object to be located is located are scanned by a three-dimensional laser scanner to obtain the first point cloud.

It is to be understood that when at least two objects to be located are placed in a material frame or tray, there is no specific requirement for the placement order, and a plurality of objects to be positioned can be arbitrarily stacked in the material frame or tray. In addition, the present disclosure makes no specific restriction on the order of acquiring a scene point cloud (i.e., a first point cloud) of a scene where the object to be located is located and acquiring a pre-stored background point cloud (i.e., a second point cloud).

102. Determine at least two target areas in the point cloud to be processed, and adjust normal vectors of points in the target areas to significant normal vectors according to initial normal vectors of the points in the target areas, any two of the at least two target areas being different.

Each of the at least two target areas contains at least one point, and a union set of the at least two target areas is a point cloud to be processed. For example, a target area A contains points a, b and c, a target area B contains points b, c and d, and a union set of the target areas A and B contains points a, b, c and d. In another example, the target area A contains points a and b, the target area B contains points c and d, and a union set of the target areas A and B contains points a, b, c and d.

Since the surface of the object to be located is usually a smooth plane or a curved surface, the point cloud to be processed should also be a smooth plane or curved surface in the absence of noise. However, if there is noise in the point cloud to be processed, the area where the noise is located in the point cloud to be processed is convex or concave, that is, the convex or concave area on the entire smooth plane or curved surface is a noise area. Obviously, on a smooth plane or a curved surface, the direction of the normal vectors of the convex area or concave area is different from the direction of the normal vectors of a non-convex area and a non-concave area, that is, the direction of the normal vectors of the points in the noise area is different from the direction of the normal vectors of a non-noise area. On this basis, the embodiment of the present disclosure determines whether the point cloud to be processed contains a noise area by means of the direction of the normal vectors of the points in the point cloud to be processed.

After acquiring the point cloud to be processed in step 101, the normal vector of each point in the point cloud to be processed, i.e., the initial normal vectors of the points in each target area, can be determined, and then whether the target area contains a noise area can be determined according to the direction of the initial normal vectors of all points or some points in the target area.

For example, there are six points in the target area A, namely, point a, point b, point c, point d, point e and point f. The normal vectors of the points a, b, c and d are all parallel to a z-axis of a camera coordinate system (origin of coordinate is o, and three axes of the coordinate system are x, y and z, respectively), and the normal vectors of the points a, b, c and d are all perpendicular to an xoy plane of the camera coordinate system. The normal vector of the point e forms an angle of 45 degrees relative to the z-axis of the camera coordinate system, an angle of 90 degrees with the x-axis of the camera coordinate system, and an angle of 60 degrees with the y-axis of the camera coordinate system, respectively. The normal vector of the point f forms an angle of 60 degrees relative to the z-axis of the camera coordinate system, an angle of 80 degrees with the x-axis of the camera coordinate system, and an angle of 70 degrees with the y-axis of the camera coordinate system, respectively. Obviously, the directions of the normal vectors of the point e and the point f are different from the direction of the normal vectors of the other four points, so it can be determined that the point e and the point f are points in the noise area, while the points a, b, c and d are points in the non-noise area.

Due to the presence of noise in the point cloud to be processed, the noise area in the point cloud to be processed is convex or concave, that is, in the absence of noise, the point cloud to be processed should be a smooth plane or a smooth curved surface, and there should be no convex area and/or concave area. Therefore, the target area can be “changed into” a smooth plane by adjusting the normal vectors of the points in the target area to significant normal vectors.

In an implementation mode of determining at least two target areas in a point cloud to be processed, at least two target points are determined in the point cloud to be processed, and at least two neighborhoods are constructed with each of the target points as a sphere center and a third preset value as a radius, respectively, that is, each target point corresponds to one neighborhood. The at least two neighborhoods are taken as the at least two target areas, that is, one neighborhood is one target area.

For convenience of description, two target areas are taken as an example, that is, the aforementioned at least two target areas include a first target area and a second target area.

In an implementation mode of determining a first target area and a second target area in a point cloud to be processed, the first target area can be acquired by constructing a second neighborhood with a fourth point (i.e., the target point) in the point cloud as a sphere center and a third preset value as a radius. The second target area can be acquired by constructing a third neighborhood with a fifth point (i.e., the target point) in the point cloud as a sphere center and the third preset value as a radius. The fourth point and the fifth point are any two different points in the point cloud to be processed. The third preset value is a positive number, and optionally, the value of the third preset value is 5 mm.

In another implementation mode of determining a first target area and a second target area in a point cloud to be processed, the first target area and the second target area can be acquired by clustering initial normal vectors of points in the point cloud.

After acquiring the first and second target areas, first significant normal vector of the first target area can be determined according to the initial normal vectors of the points in the first target area (hereinafter referred to as the first initial normal vectors), and a second significant normal vector of the second target area can be determined according to the initial normal vectors of the points in the second target area (hereinafter referred to as the second initial normal vectors). That is, each of the at least two target areas corresponds to a significant normal vector, respectively.

In a possible implementation mode of determining the first significant normal vector, the first initial normal vectors of the points in the first target area are clustered to acquire at least one cluster set. The cluster set with the largest number of the first initial normal vectors in the at least one cluster set is taken as a target cluster set, and the first significant normal vector is determined according to the first initial normal vectors in the target cluster set.

In an implementation mode of clustering the first initial normal vectors of the points in the first target area to acquire at least one cluster set, the first initial normal vector of each point in the first target area is mapped to one of at least two preset sections, and the first significant normal vector is determined according to the first initial normal vectors in the preset section containing the largest number of the first initial normal vectors.

For example, the normal vector of each point in the point cloud to be processed includes information of three directions (i.e., the positive direction of x-axis, the positive direction of y-axis and the positive direction of z-axis). A value range (−180 to 180 degrees) of an angle between the normal vector and the x-axis, a value range (−180 to 180 degrees) of an angle between the normal vector and the y-axis, and a value range (−180 to 180 degrees) of an angle between the normal vector and the z-axis are divided into two sections (one section is greater than or equal to 0 degrees and smaller than 180 degrees, and the other section is greater than or equal to 180 degrees and smaller than −180 degrees), respectively. Thus, eight sections are obtained. The angle between the normal vector falling within a first section of the eight sections and the x-axis is greater than or equal to −180 degrees and smaller than 180 degrees, the angle between the normal vector falling within a first section of the eight sections and the y-axis is greater than or equal to −180 degrees and smaller than 180 degrees, and the angle between the normal vector falling within a first section of the eight sections and the z-axis is greater than or equal to −180 degrees and smaller than 180 degrees. The angle between the normal vector falling within a second section of the eight sections and the x-axis is greater than or equal to −180 degrees and smaller than 180 degrees, the angle between the normal vector falling within a second section of the eight sections and the y-axis is greater than or equal to 0 degrees and smaller than 180 degrees, and the angle between the normal vector falling within a second section of the eight sections and the z-axis is greater than or equal to −180 degrees and smaller than 180 degrees. The angle between the normal vector falling within a third section of the eight sections and the x-axis which is greater than or equal to −180 degrees and smaller than 180 degrees, the angle between the normal vector falling within a third section of the eight sections and the y-axis is greater than or equal to −180 degrees and smaller than 180 degrees, and the angle between the normal vector falling within a third section of the eight sections and the z-axis is greater than or equal to 0 degrees and smaller than 180 degrees. The angle between the normal vector falling within a fourth section of the eight sections and the x-axis is greater than or equal to −180 degrees and smaller than 180 degrees, the angle between the normal vector falling within a fourth section of the eight sections and the y-axis is greater than or equal to 0 degrees and smaller than 180 degrees, and the angle between the normal vector falling within a fourth section of the eight sections and the z-axis is greater than or equal to 0 degrees and smaller than 180 degrees. The angle between the normal vector falling within a fifth section of the eight sections and the x-axis is greater than or equal to 0 degrees and smaller than 180 degrees, the angle between the normal vector falling within a fifth section of the eight sections and the y-axis is greater than or equal to −180 degrees and smaller than 180 degrees, and the angle between the normal vector falling within a fifth section of the eight sections and the z-axis is greater than or equal to −180 degrees and smaller than 180 degrees. The angle between the normal vector falling within a sixth section of the eight sections and the x-axis is greater than or equal to 0 degrees and smaller than 180 degrees, the angle between the normal vector falling within a sixth section of the eight sections and the y-axis is greater than or equal to 0 degrees and smaller than 180 degrees, and the angle between the normal vector falling within a sixth section of the eight sections and the z-axis is greater than or equal to −180 degrees and smaller than 180 degrees. The angle between the normal vector falling within a seventh section of the eight sections and the x-axis is greater than or equal to 0 degrees and smaller than 180 degrees, the angle between the normal vector falling within a seventh section of the eight sections and the y-axis is greater than or equal to −180 degrees and smaller than 180 degrees, and the angle between the normal vector falling within a seventh section of the eight sections and the z-axis is greater than or equal to 0 degrees and smaller than 180 degrees. The angle between the normal vector falling within an eighth section of the eight sections and the x-axis is greater than or equal to 0 degrees and smaller than 180 degrees, the angle between the falling within an eighth section of the eight sections and the y-axis is greater than or equal to 0 degrees and smaller than 180 degrees, and the angle between the falling within an eighth section of the eight sections and the z-axis is greater than or equal to 0 degrees and smaller than 180 degrees. The first initial normal vectors of all points in the first target area can be mapped to one of the above eight sections according to the angles between the first initial normal vectors of the points in the first target area and the x-axis, y-axis and z-axis. For example, if the first initial normal vector of the point a in the first target area forms an angle of 120 degrees relative to the x-axis, an angle of −32 degrees relative to the y-axis and an angle of 45 degrees relative to the z-axis, the first initial normal vector of the point a will be mapped to the seventh section. After mapping the first initial normal vectors of all points in the first target area to one of the eight sections, the number of the first initial normal vectors in each of the eight sections can be counted, and the first significant normal vector can be determined according to the first initial normal vectors in the section with the largest number. Optionally, a mean value of the first initial normal vectors in the section with the largest number can be taken as the first significant normal vector, or a median value of the first initial normal vectors in the section with the largest number can be taken as the first significant normal vector, which is not limited in the present disclosure.

In another implementation mode of clustering the first initial normal vectors of the points in the first target area to acquire at least one cluster set, the first significant normal vector can be determined according to the principle of “the minority is subordinate to the majority”. For example, the first target area includes five points, in which the first initial normal vectors of three points are vector a, and the first initial normal vectors of two points are vector b, so the first significant normal vector can be determined to be the vector a.

Similarly, the significant normal vector of any one of the at least two target areas can be determined by the above possible implementation mode. For example, the second initial normal vectors of the points in the second target area are clustered to acquire at least one second cluster set; the second cluster set with the largest number of the second initial normal vectors in the at least one second cluster set is taken as a second target cluster set, and the second significant normal vector is determined according to the second initial normal vectors in the second target cluster set; and the normal vectors of the points in the second target area are adjusted to the second significant normal vector.

The above implementation process of clustering the second initial normal vectors to acquire at least one second cluster set comprises mapping the second initial normal vectors of the points in the second target area to any one of the at least one preset section, the preset section being the value section of the vector; taking the preset section with the largest number of the second initial normal vectors as a second target preset section; and determining the second significant normal vector according to the second initial normal vectors included in the second target preset section.

After determining the first significant normal vector and the second significant normal vector, the normal vectors of all points or some points in the first target area can be adjusted from the first initial normal vectors to the first significant normal vector, and the normal vectors of all points or some points in the second target area can be adjusted from the second initial normal vectors to the second significant normal vector. In this way, the convex and concave areas in the first target area and/or the second target area are changed into smooth areas.

It is to be understood that although the first target area and the second target area are described above, in practical application the number of the target areas can be three or more, and the present disclosure makes no restriction on the number of the target areas.

103. Divide the point cloud to be processed according to the significant normal vector of the target area to acquire at least one divided area.

After determining the significant normal vector of each target area, the point cloud to be processed can be divided according to the significant normal vector of each target area. In a possible implementation mode, whether the target areas belong to the same object to be located can be determined according to a distance between the significant normal vectors of the target areas. For example, if the distance between the first significant normal vector and the second significant normal vector is less than a first distance threshold, the first target area and the second target area can be divided into the same divided area, that is, they belong to the same object to be located. If the distance between the first significant normal vector and the second significant normal vector is greater than or equal to the first distance threshold, the first target area and the second target area can be divided into two different divided areas, that is, the first target area and the second target area belong to different objects to be located.

In this step, the point cloud is divided based on the significant normal vectors obtained in step 102, which can reduce the influence of noise in the point cloud on the division accuracy, and further improve the division accuracy.

Optionally, the above dividing process can be implemented by any one of region growing, random sample consensus (RANSAC), a division method based on concavity and convexity, and a division method using neural network, which is not limited by the present disclosure.

104. Acquire a three-dimensional position of a reference point of the object to be located according to three-dimensional positions of points in the at least one divided area.

In this embodiment, each divided area corresponds to an object to be located. The above reference point is one of a centroid, a gravity center, and a geometric center.

In a possible implementation mode, a mean value of the three-dimensional positions of points in each divided area is taken as the three-dimensional position of the reference point of the object to be located. For example, if the mean value of the three-dimensional positions of the points in the divided area A is (a, b, c), the three-dimensional position of the reference point of the object to be located corresponding to the divided area A can be determined as (a, b, c).

In another possible implementation mode, a median value of the three-dimensional positions of the points in each divided area is taken as the three-dimensional position of the reference point of the object to be located. For example, if the median value of the three-dimensional positions of the points in the divided area B is (d, e, f), the three-dimensional position of the reference point of the object to be located corresponding to the divided area B can be determined as (d, e, f).

In this embodiment, the point cloud is divided according to the significant normal vectors of the target areas, so as to improve the division accuracy. Furthermore, when the three-dimensional position of the reference point of the object to be located is determined according to the three-dimensional positions of the points in the divided areas acquired by division, the accuracy of the three-dimensional position of the reference point of the object to be located can be improved.

In order to accurately locate the object to be located in space, it is necessary to determine not only the three-dimensional position of the reference point of the object to be located, but also the posture of the object to be located in the camera coordinate system. To this end, the embodiment of the present disclosure also provides a technical solution of determining the posture of the object to be located.

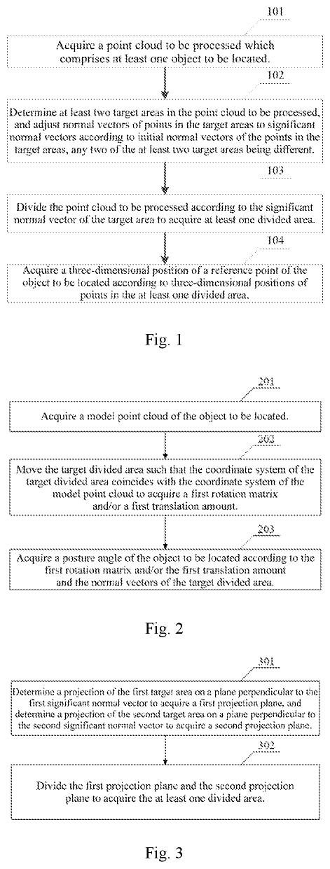

Refer to FIG. 2 which is a schematic flow diagram of another data processing method provided by an embodiment of the present disclosure.

201. Acquire a model point cloud of the object to be located.

According to the normal vectors of the points in the divided areas, the normal vectors of the object to be located corresponding to the divided areas can be determined. In a possible implementation mode, a mean value of the normal vectors of the points in the divided areas is taken as the normal vector of the object to be located corresponding to the divided areas.

After determining the normal vector of the object to be located, a posture angle of the object to be located can be determined. According to the embodiment of the present disclosure, the normal vector of the object to be located is taken as the z-axis of the object coordinate system of the object to be located, and the yaw angle of the object to be located can be determined according to the normal vector of the object to be located.

In a possible implementation mode, the mean value (i.e., a second mean value) of the normal vectors of the points in the target divided area can be taken as the normal vector of the object to be located, and then the yaw angle of the object to be located can be determined. The target divided area is any one of the at least one divided area.

If the object to be located is not rotationally symmetrical about the z-axis, when the pose of the object to be located (including the position of the reference point of the object to be located and the posture of the object to be located) is needed to grip the object to be located (such as controlling a mechanical arm or a robot to grip the object to be located), a pitch angle and a roll angle of the object to be located should be further determined, that is, the directions of the x-axis and y-axis of the object coordinate system of the object to be located should be determined. However, if the object to be located is rotationally symmetric about the z-axis, the object to be located can be gripped without determining the pitch angle and the roll angle of the object to be located. Therefore, the object to be located is an object that is rotationally symmetric about the z-axis.

Since there may be errors between the acquired divided area and the actual object to be located, there may be errors in the yaw angle of the object to be located determined by the divided area and the three-dimensional position of the reference point of the object to be located. Therefore, in this step, a model point cloud of the object to be located which is obtained by scanning the object to be located is acquired firstly. The three-dimensional position of the reference point of the model point cloud is set as the first mean value of the three-dimensional positions of the points in the target divided area obtained in step 104, and the normal vector of the model point cloud (i.e., the z-axis of the object coordinate system of the model point cloud) is set as the second mean value, so as to determine the yaw angle of the divided area and correct the three-dimensional position of the reference point of the target divided area based on the model point cloud.

202. Move the target divided area such that the coordinate system of the target divided area coincides with the coordinate system of the model point cloud to acquire a first rotation matrix and/or a first translation amount.

The model point cloud is acquired by scanning the object to be located, that is, the object coordinate system of the model point cloud is determined and accurate. Therefore, by moving and/or rotating the target divided area to make the object coordinate system of the target divided area coincide with the object coordinate system of the model point cloud, the yaw angle of the target divided area and the three-dimensional position of the reference point of the target divided area can be corrected. The first rotation matrix and/or the first translation amount can be acquired by moving the target divided area to make the coordinate system of the target divided area coincide with the coordinate system of the model point cloud.

203. According to the first rotation matrix and/or the first translation amount and the normal vectors of the target divided area, a posture angle of the object to be located is acquired.

The first mean value acquired in step 104 is multiplied by the first rotation matrix to acquire a first rotated three-dimensional position. A corrected three-dimensional position of the reference point of the target divided area can be acquired by adding the first rotated three-dimensional position and the first translation amount.

The second mean value is multiplied by the first rotation matrix to acquire a rotated normal vector. By adding the rotated normal vector to the first translation amount, a corrected normal vector of the target divided area can be acquired, and further the yaw angle of the object to be located can be determined. Optionally, because the object to be located is rotationally symmetrical about the z-axis, the pitch angle and the roll angle of the object to be located can be arbitrary values, and the posture angle of the object to be located can be acquired.

In this embodiment, by rotating and/or moving the target divided area to make the object coordinate system of the target divided area coincide with the object coordinate system of the model point cloud, so that the yaw angle of the object to be located is determined, which can improve the accuracy of the yaw angle of the object to be located and correct the three-dimensional position of the reference point of the object to be located. Moreover, the posture of the object to be located can be determined according to the yaw angle of the object to be located.

In an actual scene, a plurality of objects to be located may be stacked together, so there may be division errors when a point cloud to be processed is divided. In order to improve the division accuracy of the point cloud, an embodiment of the present disclosure provides a method of projecting target areas (including a first target area and a second target area) based on significant normal vectors thereof, and dividing planes obtained by the projection.

Refer to FIG. 3 which is a flow diagram of another data processing method provided by an embodiment of the present disclosure.

301. Determine projection of the first target area on a plane perpendicular to the first significant normal vector to acquire a first projection plane, and determine projection of the second target area on a plane perpendicular to the second significant normal vector to acquire a second projection plane.

The first projection plane can be acquired by projecting the first target area according to the first significant normal vector, and the second projection plane can be acquired by projecting the second target area according to the second significant normal vector. When the direction of the first significant normal vector is different from that of the second significant normal vector, a distance between the first projection plane and the second projection plane is greater than that between the first target area and the second target area. That is, in this step, by projecting the first target area and the second target area, the distance between the first target area and the second target area can be increased.

302. Divide the first projection plane and the second projection plane to acquire the at least one divided area.

Since the distance between the first target area and the second target area is small, if the first target area and the second target area are divided, there may be a big division error. For example, points that do not belong to the same object to be located are divided into the same divided area. Since the distance between the first projection plane and the second projection plane is greater than the distance between the first target area and the second target area, the division accuracy can be improved by dividing the first projection plane and the second projection plane.

In an implementation mode of dividing the first projection plane and the second projection plane, a first neighborhood is constructed with any point in the first projection plane and the second projection plane as a starting point (hereinafter referred to as a first starting point) and a first preset value as a radius. A point in the first neighborhood whose similarity with the first starting point is greater than or equal to a first threshold is determined as a first target point. Areas containing the first target point and the first starting point are taken as divided areas to be confirmed. A second starting point different from the first starting point in the divided area to be confirmed is selected, and a fourth neighborhood is constructed with the second starting point as a center and the first preset value as a radius. A point in the fourth neighborhood whose similarity with the second starting point is greater than or equal to the first threshold value is determined as a second target point. The second target point is included in the divided area to be confirmed. The steps of selecting the starting points, constructing the neighborhoods and acquiring the target points are circularly executed until it is impossible to acquire a point in the projection plane whose similarity with the starting point of the neighborhood is greater than or equal to the first threshold, and the divided area to be confirmed is determined as the divided area. The first preset value is a positive number, and optionally, the first preset value is 5 mm. The first threshold is a positive number, and optionally, the first threshold is 85%.

In this embodiment, the distance between the first target area and the second target area is increased by projecting the first target area and the second target area, which achieves the effect of improving the division accuracy, and further improving the accuracy of the acquired pose of the object to be located.

An embodiment of the present disclosure further provides a technical solution of improving the accuracy of the pose of the object to be located.

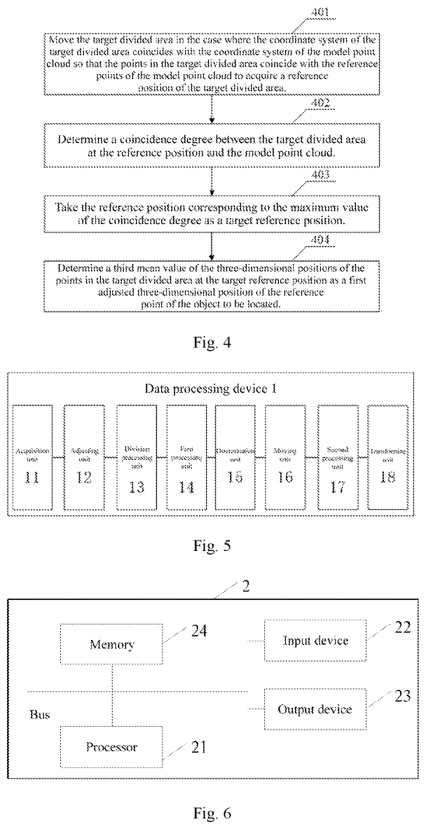

Refer to FIG. 4 which is a flow diagram of another data processing method provided by an embodiment of the present disclosure.

401. In the case where the coordinate system of the target divided area coincides with the coordinate system of the model point cloud, the target divided area is moved to make the points in the target divided area coincide with the reference point of the model point cloud to acquire a reference position of the target divided area.

As described in step 201, there may be errors between the target divided area and the actual object to be located, so there may also be errors between the reference point of the target divided area and the reference point of the actual object to be located, which leads to low precision of the three-dimensional position of the reference point of the object to be located determined according to the three-dimensional position of the reference point of the target divided area. In this step, when the object coordinate system of the target divided area coincides with the object coordinate system of the model point cloud (i.e., the object coordinate system of the target divided area acquired after step 202 is executed), the target divided area is moved to make any point in the target divided area coincide with the reference point of the model point cloud to acquire the reference position of the target divided area, so as to determine the three-dimensional position of the reference point in the target divided area based on the reference position.

402. Determine a coincidence degree between the target divided area at the reference position and the model point cloud.

In this embodiment, the coincidence degree includes a ratio between the number of the points in the target divided area that coincide with the points in the model point cloud and the number of the points in the model point cloud. The distance between two points is negatively correlated with the coincidence degree between the two points.

By moving the target divided area to make the points in the target divided area coincide with the reference point of the model point cloud in sequence, for each time of coincidence, a closest point in the model point cloud to each point in the target divided area is determined, and a distance between each point in the target divided area and its closest point is determined. The number of the points in the target divided area that coincide with the points in the model point cloud (the distance between two points which coincide with each other is smaller than or equal to the second distance threshold) is determined, and then the coincidence degree between the target divided area and the model point cloud for each coincidence can be determined. Optionally, determining a closest point in the model point cloud to each point in the target divided area can be implemented by any of the following algorithms: k-dimensional tree search method and traversal search method.

In a possible implementation mode of determining a coincidence degree between the target divided area at the reference position and the model point cloud, a distance between a first point in the target divided area at the reference position and a second point in the model point cloud is determined, the second point being a point in the model point cloud closest to the first point. When the distance is smaller than or equal to a second threshold (i.e., the second distance threshold), a coincidence degree index of the reference position is increased by a second preset value. The coincidence degree is determined based on the coincidence degree index which is positively correlated with the coincidence degree. The second threshold is a positive number, and optionally second threshold is 0.3 mm.

The first point is any point in the target divided area at the reference position. The second preset value is a positive number, and optionally the second preset value is 1. For example (Example 1), it is assumed that the target divided area at the reference position includes points a, b and c, and the model point cloud includes points d, e, f and g. The point d is the closest point in the model point cloud to the point a, and the distance between the point a and the point d is d₁. The point e is the closest point in the model point cloud to the point b, and the distance between the point b and the point e is d₂. The point f is the closest point in the model point could to the point c, and the distance between the point c and the point f is d₃. The d₁ is greater than the second threshold and d₂ is smaller than the second threshold, and accordingly the coincidence degree index can be increased by 1. The d₃ is equal to the second threshold, and accordingly the coincidence degree index is increased by 1. The coincidence degree index between the target divided area at the reference position and the model point cloud is 2.

After the coincidence degree index of each coincidence is determined, it can be determined that the coincidence degree between the target divided area corresponding to a maximum value of the coincidence degree index and the model point cloud is the maximum, and then it can be determined that the three-dimensional position of the point which coincides with the reference point of the model point cloud in the target divided area when the coincidence degree is the maximum is the three-dimensional position of the reference point of the target divided area.

For a further example (Example 2), the reference point in the model point cloud is the point f. When the point a and the point f coincide with each other, the coincidence degree index between the target divided area and the model point cloud is 1. When the point b and the point f coincide with each other, the coincidence degree index between the target divided area and the model point cloud is 1. When the point c and the point f coincide with each other, the coincidence degree index between target divided area and the model point cloud is 2. At this time, the target divided area corresponding to the maximum value of the coincidence degree index is the target divided area when the point c and the point f coincide with each other, that is, when the point c and the point f coincide with each other by moving the target divided area, the coincidence degree between the target divided area and the model point cloud is maximum.

403. Take the reference position corresponding to the maximum value of the coincidence degree as a target reference position.

For a further example, it is assumed that the reference position when the point c coincides with the point f by moving the target divided area is a first reference position, and the first reference position is the target reference position in this case.

404. Determine a third mean value of the three-dimensional positions of the points in the target divided area at the target reference position as a first adjusted three-dimensional position of the reference point of the object to be located.

The coincidence degree between the target divided area at the target reference position and the model point cloud is maximum, representing that the accuracy of the three-dimensional positions of the points in the target divided area at the target reference position is the highest. Therefore, the third mean value of the three-dimensional positions of the points in the target divided area at the target reference position is calculated, and the third mean value is taken as a first adjusted three-dimensional position of the reference point of the object to be located.

In this embodiment, the target reference position of the target divided area is determined according to the coincidence degree between the target divided area and the model point cloud, and then the first adjusted three-dimensional position of the reference point of the object to be located is determined, so as to achieve the effect of improving the accuracy of the three-dimensional position of the reference point of the object to be located.

It is to be understood that what is described in the embodiments is the processing performed on the target divided area (hereinafter referred to as the target processing), but in practical application, the target processing can be performed on each area of the at least one divided area. For example, at least one divided area includes a divided area A, a divided area B and a divided area C. In practical application, the target processing can be performed on the divided area A, but not on the divided areas B and C. It is also possible to perform the target processing on the divided areas A and B, but not on the divided area C. It is also possible to perform the target processing on the divided areas A, B and C.

The present disclosure further provides another technical solution for improving the accuracy of the pose of the object to be located. According to the technical solution, the three-dimensional position of the reference point of the model point cloud is adjusted to the third mean value. By rotating and/or translating the target divided area at the target reference position, the distance between the first point and the third point in the model point cloud is smaller than or equal to a third threshold, and a second rotation matrix and/or a second translation amount are acquired. The three-dimensional position of the reference point of the object to be located is adjusted according to the second rotation matrix and/or the second translation amount to acquire a second adjusted three-dimensional position of the reference point of the object to be located. The posture angle of the object to be located is adjusted according to the second rotation matrix and/or the second translation amount to acquire an adjusted posture angle of the object to be located.

In this technical solution, the first point is any point in the target divided area, and the third point is the point closest to the first point in the model point cloud after the three-dimensional position of the reference point is adjusted to the third mean value. The above third threshold is a positive number, and optionally the third threshold is 0.3 mm. When the distance between the first point and the third point is smaller than or equal to the third threshold, it indicates that the coincidence degree between the target divided area and the model point cloud meets the expectation, that is, the accuracy of the position of the target divided area meets the expectation. The second rotation matrix and/or the second translation amount can be acquired by rotating and/or moving the target divided area to make the distance between the first point and the third point smaller than or equal to the third threshold. The acquired three-dimensional position of the reference point of the object to be located is multiplied by the second rotation matrix to acquire a second rotated three-dimensional position. The second rotated three-dimensional position is added to the second translation amount to acquire a second adjusted three-dimensional position of the reference point of the object to be located. The obtained posture angle of the object to be located (here, the target divided area can be translated and is not rotated) is multiplied by the second rotation matrix to acquire a rotated posture angle. The rotated posture angle is added to the second translation amount to acquire an adjusted posture angle of the object to be located.

After acquiring the pose of the object to be located by the technical solution provided by the embodiment of the present disclosure, the mechanical claw can be controlled to grip the object to be located according to the pose of the object to be located. However, in practical application, there may be “obstacles” in the gripping path along which the mechanical claw grips the object to be located. If there are “obstacles” in the gripping path, the gripping success rate of the mechanical claw will be affected. Therefore, an embodiment of the present disclosure provides a method for determining whether to grip an object to be located based on detection of “obstacles” in the gripping path.

The aforementioned pose of the object to be located and the adjusted pose of the object to be located are poses of the object to be located in the camera coordinate system, while the gripping path of the mechanical claw is a curve in the world coordinate system. Therefore, when determining the gripping path of the mechanical claw, the pose of the object to be located (or the adjusted pose of the object to be located) can be multiplied by a transformation matrix to acquire a pose of the object to be located in the world coordinate system (including a three-dimensional position to be gripped and a posture angle to be gripped). The transformation matrix is a coordinate system transformation matrix between the camera coordinate system and the world coordinate system. Meanwhile, a mechanical claw model and an initial pose of the mechanical claw model can be obtained.

According to the three-dimensional position to be gripped, the posture angle to be gripped, the mechanical claw model and the initial pose of the mechanical claw model, a gripping path for the mechanical claw to grip the object to be located in the world coordinate system can be obtained. By transforming the gripping path for the mechanical claw to grip the object to be located in the world coordinate system into a gripping path for the mechanical claw to grip the object to be located in the camera coordinate system, a gripping path for the mechanical claw to grip the object to be located in the point cloud can be obtained.

By determining the number of points not belonging to the object to be located in the gripping path for the mechanical claw to grip the object to be located in the point cloud, the “obstacles” in the gripping path for the mechanical claw to grip the object to be located are determined. If the number of points that do not belong to the object to be located in the gripping path is greater than or equal to a fourth threshold, it indicates that there are “obstacles” in the gripping path, and the object to be located cannot be gripped, that is, the object to be located is a non-grippable object. If the number of points that do not belong to the object to be located in the gripping path is smaller than the fourth threshold, it indicates that there is no “obstacle” in the gripping path, and the object to be located can be gripped, that is, the object to be located is a grippable object. The fourth threshold is a positive integer, and optionally the fourth threshold is 5.

By determining the number of points that do not belong to the object to be located in the gripping path, it can be determined whether there are “obstacles” in the gripping path, and it can further be determined whether the object to be located is a grippable object. In this way, the success rate of gripping the object to be located by the mechanical claw can be improved, and the probability of occurrence of accidents when gripping the object to be located due to the existence of “obstacles” in the gripping path can be reduced.

It will be appreciated by those skilled in the art that in the above method of the specific embodiment, the sequence of the steps does not mean a strict execution order and does not constitute any restriction on the implementation, and the specific execution order of the steps should be determined by functions and possible internal logic thereof.

The methods according to the embodiments of the present disclosure are described above in detail, and devices according to the embodiments of the present disclosure are provided below.

Referring to FIG. 5 which is a schematic structural diagram of a data processing device provided by an embodiment of the present disclosure, the device 1 comprises an acquisition unit 11, an adjusting unit 12, a division processing unit 13, a first processing unit 14, a determination unit 15, a moving unit 16, a second processing unit 17 and a transforming unit 18, wherein

the acquisition unit 11 is configured to acquire a point cloud to be processed, the point cloud to be processed comprising at least one object to be located;

the adjusting unit 12 is configured to determine at least two target areas in the point cloud to be processed, and adjust normal vectors of points in the target areas to significant normal vectors according to initial normal vectors of the points in the target areas, any two of the at least two target areas being different;

the division processing unit 13 is configured to divide the point cloud to be processed according to the significant normal vectors of the target areas to acquire at least one divided area; and

the first processing unit 14 is configured to acquire a three-dimensional position of a reference point of the object to be located according to three-dimensional positions of points in the at least one divided area.

In a possible implementation mode, the at least two target areas comprise a first target area and a second target area, the initial normal vectors comprise a first initial normal vector and a second initial normal vector, and the significant normal vectors comprise a first significant normal vector and a second significant normal vector; and the adjusting unit 12 is configured to adjust the normal vectors of the points in the first target area to the first significant normal vector according to the first initial normal vectors of the points in the first target area, and adjust the normal vectors of the points in the second target area to the second significant normal vector according to the second initial normal vectors of the points in the second target area.

In another possible implementation mode, the division processing unit 13 is configured to divide the point cloud to be processed according to the first significant normal vector and the second significant normal vector to acquire the at least one divided area.

In yet another possible implementation mode, the adjusting unit 12 is configured to cluster the first initial normal vectors of the points in the first target area to acquire at least one cluster set; a cluster set with the largest number of the first initial normal vectors in the at least one cluster set is taken as a target cluster set, and the first significant normal vector is determined according to the first initial normal vectors in the target cluster set.

The normal vectors of the points in the first target area are adjusted to the first significant normal vector.

In yet another possible implementation mode, the adjusting unit 12 is specifically configured to map the first initial normal vectors of the points in the first target area to any one of at least one preset section, the preset section being used for representing vectors, vectors represented by any two of the at least one preset section being different; the preset section with the largest number of the first initial normal vectors is taken as a target preset section; and the first significant normal vector is determined according to the first initial normal vectors included in the target preset section.

In yet another possible implementation mode, the adjusting unit 12 is specifically configured to determine a mean value of the first initial normal vectors in the target preset section as the first significant normal vector; or, determine a median value of the first initial normal vectors in the target preset section as the first significant normal vector.

In yet another possible implementation mode, the division processing unit 13 is configured to determine projection of the first target area on a plane perpendicular to the first significant normal vector to acquire a first projection plane; determine projection of the second target area on a plane perpendicular to the second significant normal vector to acquire a second projection plane; and divide the first projection plane and the second projection plane to acquire the at least one divided area.

In yet another possible implementation mode, the division processing unit 13 is specifically configured to construct a first neighborhood with any point in the first projection plane and the second projection plane as a starting point and a first preset value as a radius; determine a point in the first neighborhood whose similarity with the starting point is greater than or equal to a first threshold as a target point; and take areas containing the target point and the starting point as divided areas to acquire the at least one divided area.

In yet another possible implementation mode, the first processing unit 14 is configured to determine a first mean value of the three-dimensional positions of the points in a target divided area in the at least one divided area; and determine the three-dimensional position of the reference point of the object to be located according to the first mean value.

In yet another possible implementation mode, the device 1 further comprises a determination unit 15 configured to determine a second mean value of the normal vectors of the points in the target divided area after determining the first mean value of the three-dimensional positions of the points in the at least one divided area; the acquisition unit 11 configured to acquire a model point cloud of the object to be located, wherein an initial three-dimensional position of the model point cloud is the first mean value, and a pitch angle of the model point cloud is determined by the second mean value; a moving unit 16 configured to move the target divided area to make a coordinate system of the target divided area coincide with a coordinate system of the model point cloud to acquire a first rotation matrix and/or a first translation amount; and the first processing unit 14 configured to acquire a posture angle of the object to be located according to the first rotation matrix and/or the first translation amount and the normal vectors of the target divided area.

In yet another possible implementation mode, the moving unit 16 is further configured to move the target divided area such that the points in the target divided area coincide with the reference point of the model point cloud in the case where the coordinate system of the target divided area coincides with the coordinate system of the model point cloud, to acquire a reference position of the target divided area; the determination unit 15 is further configured to determine a coincidence degree between the target divided area at the reference position and the model point cloud; the determination unit 15 is further configured to take the reference position corresponding to a maximum value of the coincidence degree as a target reference position; and the first processing unit 14 is configured to determine a third mean value of the three-dimensional positions of the points in the target divided area at the target reference position as a first adjusted three-dimensional position of the reference point of the object to be located.

In yet another possible implementation mode, the determination unit 15 is specifically configured to determine a distance between a first point in the target divided area at the reference position and a second point in the model point cloud, the second point being a point closest to the first point in the model point cloud; in the case where the distance is smaller than or equal to a second threshold, increase a coincidence degree index of the reference position by a second preset value; and determine the coincidence degree according to the coincidence degree index, the coincidence degree index being positively correlated with the coincidence degree.

In yet another possible implementation mode, the adjusting unit 12 is further configured to adjust the three-dimensional position of the reference point of the model point cloud to the third mean value; the device 1 further comprise a second processing unit 17 configured to make the distance between the first point and a third point in the model point cloud smaller than or equal to a third threshold by rotating and/or translating the target divided area at the target reference position to acquire a second rotation matrix and/or a second translation amount, the third point being a point in the model point cloud closest to the first point when the three-dimensional position of the reference point is the third mean value; and the first processing unit 14 further configured to adjust the three-dimensional position of the reference point of the object to be located according to the second rotation matrix and/or the second translation amount to acquire a second adjusted three-dimensional position of the reference point of the object to be located, and adjust the posture angle of the object to be located according to the second rotation matrix and/or the second translation amount to acquire an adjusted posture angle of the object to be located.

In yet another possible implementation mode, the device 1 further comprises a transforming unit 18 configured to transform the three-dimensional position of the reference point of the object to be located and the posture angle of the object to be located into a three-dimensional position to be gripped and a posture angle to be gripped in a robot coordinate system; the acquisition unit 11 further configured to acquire a mechanical claw model and an initial pose of the mechanical claw model; the first processing unit 14 further configured to acquire a gripping path for the mechanical claw to grip the object to be located in the point cloud according to the three-dimensional position to be gripped, the posture angle to be gripped, the mechanical claw model and the initial pose of the mechanical claw model; and the determination unit 15 further configured to determine that the object to be located is a non-grippable object when the number of the points which do not belong to the object to be located in the gripping path is greater than or equal to a fourth threshold.

In yet another possible implementation mode, the adjusting unit 12 is configured to determine at least two target points in the point cloud; and construct the at least two target areas by taking each of the at least two target points as a sphere center and a third preset value as a radius, respectively.

In yet another possible implementation mode, the acquisition unit 11 is configured to acquire a first point cloud and a second point cloud, wherein the first point cloud comprises a point cloud of a scene where the at least one object to be located is located, and the second point cloud comprises the at least one object to be located and a point could of a scene where the at least one object to be located is located; determine identical data in the first point cloud and the second point cloud; and remove the identical data from the second point cloud to acquire the point cloud to be processed.

In yet another possible implementation mode, the reference point is one of a centroid, a gravity center and a geometric center.

In some embodiments, the functions of the device or the modules included in the device provided by the embodiments of the present disclosure can be used to implement the methods described in the above method embodiments, and the specific implementation modes are comprehensible by referring to the description of the above method embodiments, which is not repeated here for brevity.

In this embodiment, the point cloud is divided according to the significant normal vectors of the target area, so as to improve the division accuracy. Furthermore, when the three-dimensional position of the reference point of the object to be located is determined according to the three-dimensional positions of the points in the divided areas obtained by division, the accuracy of the three-dimensional position of the reference point of the object to be located can be improved.

FIG. 6 is a schematic diagram of a hardware structure of a data processing device provided by an embodiment of the present disclosure. The data processing device 2 comprises a processor 21, a memory 22, an input device 23 and an output device 24. The processor 21, the memory 22, the input device 23 and the output device 24 are coupled by a connector which includes various interfaces, transmission lines, buses, or the like, which is not limited by the embodiments of the present disclosure. It is to be understood that according to the embodiments of the present disclosure, coupling refers to mutual connection through specific ways, including direct connection or indirect connection via other devices, for example, connection via various interfaces, transmission lines, buses, etc.

The processor 21 may be one or more graphics processing units (GPUs). If the processor 21 is a GPU, the GPU may be a single-core GPU or a multi-core GPU. Optionally, the processor 21 may be a processor group composed of a plurality of GPUs, and a plurality of processors are coupled with each other by one or more buses. Optionally, the processor can also be other types of processors, etc., which is not limited by the embodiments of the present disclosure.

The memory 22 can be used to store computer program instructions, and various computer program codes including program codes for implementing the technical solution of the present disclosure. Optionally, the memory includes but is not limited to random access memory (RAM), read-only memory (ROM), erasable programmable read-only memory (EPROM), or compact disc read-only memory (CD-ROM). The memory is used for related instructions and data.

The input device 23 is used for inputting data and/or signals, and the output device 24 is used for outputting data and/or signals. The input device 23 and the output device 24 may be independent devices or an integral device.

It will be understood that according to the embodiments of the present disclosure, the memory 22 can be used to store not only related instructions but also related data. For example, the memory 22 can be used to store the point cloud to be processed acquired by the input device 23, or the memory 22 can also be used to store the pose of the object to be located acquired by the processor 21, or the like. The embodiments of the present disclosure do not limit the specific data stored in the memory.

It is to be understood that FIG. 6 only shows a simplified design of the data processing device. In practical application, the data processing device may further include other necessary elements, including but not limited to any number of input/output devices, processors, memories, etc. All data processing devices that can implement the embodiments of the present disclosure are within the protection scope of the present disclosure.

An embodiment of the present disclosure further provides a computer program. The computer program includes computer readable codes, when run in an electronic apparatus, a processor in the electronic apparatus executes the steps for implementing the above method.

It will be appreciated by those skilled in the art that the units and the algorithm steps in each embodiment of the present disclosure described herein can be implemented by electronic hardware, or a combination of computer software and electronic hardware. Whether these functions are executed in hardware or software depends on the specific application and design constraints of the technical solution. Those skilled in the art can use different methods to execute the described functions for respective specific applications, but such execution should not be considered beyond the scope of the present disclosure.

It can be clearly understood by those skilled in the art that for the convenience and conciseness of description, the specific working processes of the aforementioned systems, devices and units are comprehensible by referring to the corresponding processes in the aforementioned method embodiments, and thus will not be described in detail here. It can also be clearly understood by those skilled in the art that each embodiment of the present disclosure has its own emphasis. For convenience and conciseness of description, the same or similar parts may not be repeated in different embodiments. Therefore, for the part that is not described or not described in detail in one embodiment, please refer to the description in other embodiments.

In some embodiments provided by the present disclosure, it is to be understood that the disclosed systems, devices and methods can be implemented in other ways. For example, the device embodiments described above are only schematic, and for example, the division of the units is simply based on logical functions. In actual implementation, however, there may be another division method, for example, a plurality of units or components can be combined or integrated into another system, or some features can be ignored or not implemented. In addition, the mutual coupling or direct coupling or communication connection shown or discussed may be indirect coupling or communication connection by some interfaces, devices or units, and may be in electrical, mechanical or other forms.

The units described as separated components may or may not be physically separated, and the components shown as units may or may not be physical units, that is, they may be located in one place or distributed on a plurality of network units. Some or all of the units can be selected according to actual needs to achieve the purpose of the technical solution of this embodiment of the present disclosure.

In addition, the respective functional units in the respective embodiments of the present disclosure may be integrated into one first processing unit, or may physically exist separately, or two or more units may be integrated into one unit.

The above embodiments can be implemented in whole or in part by way of software, hardware, firmware or any combination thereof. When implemented by way of software, it can be implemented in whole or in part in the form of a computer program product. The computer program product includes one or more computer instructions. When the computer program instructions are loaded and executed on a computer, the flow or function according to the embodiment of the present disclosure is generated in whole or in part. The computer can be a general purpose computer, a dedicated computer, computer network, or other programmable data processing devices. The computer instructions may be stored in a volatile computer readable storage medium or a nonvolatile computer readable storage medium, or transmitted by the computer readable storage medium. The computer instructions can be transmitted from one website, computer, server or data center to another by way of a wired (such as coaxial cable, optical fiber, digital subscriber line (DSL)) or wireless (such as infrared, wireless, microwave, etc.) method. The computer readable storage medium can be any available medium that can be accessed by a computer, or data storage devices such as servers and data centers that contain one or more available media integrations. The available media can be magnetic media (e.g., floppy disk, hard disk, magnetic tape), optical media (e.g., digital versatile disc (DVD)), semiconductor media (e.g., solid state disk (SSD)), or the like.

Those of ordinary skill in the art can understand the entirety or part of the flow for implementing the methods according to the above embodiments, which can be completed by a computer program instructing related hardware. The program can be stored in a computer readable storage medium. When executed, the program can include the flow of the above method embodiments. The aforementioned storage medium includes read-only memory (ROM) or random access memory (RAM), magnetic disk or optical disk, and other media that can store program codes.

What is claimed is:

1. A data processing method, comprising:
acquiring a point cloud to be processed, the point cloud to be processed including at least one object to be located;
determining at least two target areas in the point cloud to be processed, and adjusting normal vectors of points in the target areas to significant normal vectors according to initial normal vectors of the points in the target areas, any two of the at least two target areas being different;
dividing the point cloud to be processed according to the significant normal vectors of the target areas to acquire at least one divided area; and
acquiring a three-dimensional position of a reference point of the object to be located according to three-dimensional positions of points in the at least one divided area.

2. The method according to claim 1, wherein the at least two target areas include a first target area and a second target area, the initial normal vectors include a first initial normal vector and a second initial normal vector, and the significant normal vectors include a first significant normal vector and a second significant normal vector; and
adjusting the normal vectors of the points in the target areas to the significant normal vectors according to the initial normal vectors of the points in the target areas comprises:
adjusting normal vectors of points in the first target area to the first significant normal vector according to the first initial normal vectors of the points in the first target area, and adjusting normal vectors of points in the second target area to the second significant normal vector according to the second initial normal vectors of the points in the second target area.

3. The method according to claim 2, wherein dividing the point cloud to be processed according to the significant normal vectors of the target areas to acquire at least one divided area comprises:
dividing the point cloud to be processed according to the first significant normal vector and the second significant normal vector to acquire the at least one divided area.

4. The method according to claim 2, wherein adjusting the normal vectors of the points in the first target area to the first significant normal vector according to the first initial normal vectors of the points in the first target area comprises:
clustering the first initial normal vectors of the points in the first target area to acquire at least one cluster set;
taking the cluster set with a largest number of the first initial normal vectors in the at least one cluster set as a target cluster set, and determining the first significant normal vector according to the first initial normal vectors in the target cluster set; and
adjusting the normal vectors of the points in the first target area to the first significant normal vector.

5. The method according to claim 4, wherein clustering the first initial normal vectors to acquire the at least one cluster set comprises:
mapping the first initial normal vectors of the points in the first target area into any one of at least one preset section, the preset section being a value section of the vectors;
taking the preset section with a largest number of the first initial normal vectors as a target preset section; and
determining the first significant normal vector according to the first initial normal vectors included in the target preset section.

6. The method according to claim 5, wherein determining the first significant normal vector according to the first initial normal vectors included in the target preset section comprises:
determining a mean value of the first initial normal vectors in the target preset section as the first significant normal vector; or
determining a median value of the first initial normal vectors in the target preset section as the first significant normal vector.

7. The method according to claim 3, wherein dividing the point cloud to be processed according to the first significant normal vector and the second significant normal vector to acquire the at least one divided area comprises:
determining a projection of the first target area on a plane perpendicular to the first significant normal vector to acquire a first projection plane;
determining a projection of the second target area on a plane perpendicular to the second significant normal vector to acquire a second projection plane; and
dividing the first projection plane and the second projection plane to acquire the at least one divided area.

8. The method according to claim 7, wherein dividing the first projection plane and the second projection plane to acquire the at least one divided area comprises:
constructing a first neighborhood with any point in the first projection plane as a starting point and a first preset value as a radius;
determining a point in the first neighborhood, whose similarity with the starting point is greater than or equal to a first threshold, as a target point; and
taking areas containing the target point and the starting point as divided areas to acquire the at least one divided area.

9. The method according to claim 1, wherein acquiring the three-dimensional position of the reference point of the object to be located according to the three-dimensional positions of the points in the at least one divided area comprises:
determining a first mean value of the three-dimensional positions of the points in a target divided area in the at least one divided area; and
determining the three-dimensional position of the reference point of the object to be located according to the first mean value.

10. The method according to claim 9, wherein after determining the first mean value of the three-dimensional positions of the points in the at least one divided area, the method further comprises:
determining a second mean value of the normal vectors of the points in the target divided area;
acquiring a model point cloud of the object to be located, an initial three-dimensional position of the model point cloud being the first mean value, and a pitch angle of the model point cloud being determined by the second mean value;
moving the target divided area to make a coordinate system of the target divided area coincide with a coordinate system of the model point cloud to acquire a first rotation matrix and/or a first translation amount; and
acquiring a posture angle of the object to be located according to the first rotation matrix and/or the first translation amount and the normal vectors of the target divided area.

11. The method according to claim 10, wherein the method further comprises:
moving the target divided area in a case where the coordinate system of the target divided area coincides with the coordinate system of the model point cloud such that the points in the target divided area coincide with the reference point of the model point cloud, to acquire a reference position of the target divided area;
determining a coincidence degree between the target divided area at the reference position and the model point cloud;
taking the reference position corresponding to a maximum value of the coincidence degree as a target reference position; and
determining a third mean value of the three-dimensional positions of the points in the target divided area at the target reference position, as a first adjusted three-dimensional position of the reference point of the object to be located.

12. The method according to claim 11, wherein determining the coincidence degree between the target divided area at the reference position and the model point cloud comprises:
determining a distance between a first point in the target divided area at the reference position and a second point in the model point cloud, the second point being a point in the model point cloud closest to the first point;
increasing a coincidence degree index of the reference position by a second preset value in a case where the distance is smaller than or equal to a second threshold; and
determining the coincidence degree according to the coincidence degree index, the coincidence degree index being positively correlated with the coincidence degree.

13. The method according to claim 12, wherein the method further comprises:
adjusting the three-dimensional position of the reference point of the model point cloud to the third mean value;
rotating and/or translating the target divided area at the target reference position to make the distance between the first point and a third point in the model point cloud smaller than or equal to a third threshold to acquire a second rotation matrix and/or a second translation amount, the third point being a point in the model point cloud when the three-dimensional position of the reference point is the third mean value closest to the first point; and
adjusting the three-dimensional position of the reference point of the object to be located according to the second rotation matrix and/or the second translation amount to acquire a second adjusted three-dimensional position of the reference point of the object to be located, and adjusting the posture angle of the object to be located according to the second rotation matrix and/or the second translation amount to acquire an adjusted posture angle of the object to be located.

14. The method according to claim 10, wherein the method further comprises:
transforming the three-dimensional position of the reference point of the object to be located and the posture angle of the object to be located into a three-dimensional position to be gripped and a posture angle to be gripped in a robot coordinate system;
acquiring a mechanical claw model and an initial pose of the mechanical claw model;
acquiring a gripping path for the mechanical claw to grip the object to be located in the point cloud according to the three-dimensional position to be gripped, the posture angle to be gripped, the mechanical claw model, and the initial pose of the mechanical claw model; and
determining that the object to be located is a non-grippable object when a number of the points not belonging to the object to be located in the gripping path is greater than or equal to a fourth threshold.

15. The method according to claim 1, wherein determining at least two target areas in the point cloud to be processed comprises:
determining at least two target points in the point cloud; and
constructing the at least two target areas by taking each of the at least two target points as a sphere center and a third preset value as a radius, respectively.

16. The method according to claim 1, wherein acquiring the point cloud to be processed comprises:
acquiring a first point cloud and a second point cloud, wherein the first point cloud comprises a point cloud of a scene where the at least one object to be located is located, and the second point cloud comprises the at least one object to be located and a point could of a scene where the at least one object to be located is located;
determining identical data in the first point cloud and the second point cloud; and
removing the identical data from the second point cloud to acquire the point cloud to be processed.

17. The method according to claim 1, wherein the reference point is one of a centroid, a gravity center, and a geometric center.

18. A data processing device, comprising:
a processor; and
a memory configured to store processor-executable instructions,
wherein the processor is configured to invoke the instructions stored in the memory, so as to:
acquire a point cloud to be processed, the point cloud to be processed including at least one object to be located;
determine at least two target areas in the point cloud to be processed, and adjust normal vectors of points in the target areas to significant normal vectors according to initial normal vectors of the points in the target areas, any two of the at least two target areas being different;
divide the point cloud to be processed according to the significant normal vectors of the target areas to acquire at least one divided area; and
acquire a three-dimensional position of a reference point of the object to be located according to three-dimensional positions of points in the at least one divided area.

19. The device according to claim 18, wherein the at least two target areas comprise a first target area and a second target area, the initial normal vectors comprise a first initial normal vector and a second initial normal vector, and the significant normal vectors comprise a first significant normal vector and a second significant normal vector; and
adjusting the normal vectors of the points in the target areas to the significant normal vectors according to the initial normal vectors of the points in the target areas comprises
adjust the normal vectors of the points in the first target area to the first significant normal vector according to the first initial normal vectors of the points in the first target area, and adjust the normal vectors of the points in the second target area to the second significant normal vector according to the second initial normal vectors of the points in the second target area.

20. A non-transitory computer readable storage medium in which a computer program is stored, the computer program comprising a program instruction which, when executed by a processor of an electronic apparatus, causes the processor to carry out a method of:
acquiring a point cloud to be processed, the point cloud to be processed including at least one object to be located;
determining at least two target areas in the point cloud to be processed, and adjusting normal vectors of points in the target areas to significant normal vectors according to initial normal vectors of the points in the target areas, any two of the at least two target areas being different;
dividing the point cloud to be processed according to the significant normal vectors of the target areas to acquire at least one divided area; and
acquiring a three-dimensional position of a reference point of the object to be located according to three-dimensional positions of points in the at least one divided area.
